(19) United States
(12) Patent Application Publication
(10) Pub. No.: US 2013/0268351 A1
(43) Pub. Date: Oct. 10, 2013

(54) VERIFIED ONLINE IMPRESSIONS

(71) Applicant: COMSCORE, INC., Reston, VA (US)

(72) Inventors: Magid Abraham, Great Falls, VA (US); Linda Abraham, Great Falls, VA (US); Anne Hunter, Canton, CT (US); Yon Nuta, Washington, DC (US); Greg Harrison, Seattle, WA (US)

(73) Assignee: COMSCORE, INC., Reston, VA (US)

(21) Appl. No.: 13/768,540

(22) Filed: Feb. 15, 2013

Related U.S. Application Data
(60) Provisional application No. 61/620,726, filed on Apr. 5, 2012.

(51) Int. Cl. G06Q 30/02

(52) U.S. Cl. CPC G06Q 30/0246
USPC 705/14.45

(57) ABSTRACT

The present disclosure addresses improvements to online advertising, including improvements that verify, validate, or otherwise confirm that online ad impressions and/or online ad views and the like meet the needs of advertisers. In various embodiments, the data describing online ad impressions and/or online ad views is tested to validate or verify that the data satisfies various criteria defined by or for advertisers, such as demographic, brand safety, visibility, geographic or anti-fraud requirements. The present disclosure also describes improvements in measurements and metrics that describe advertising audiences and effectiveness based on the data describing validated online ad impressions.

### RELATED APPLICATIONS

This application claims the benefit of U.S. Provisional Application No. 61/620,726, filed 5 Apr. 2012 with attorney docket number 0144.6009, which is hereby incorporated herein by reference in its entirety.

### BACKGROUND

Internet audience measurement may be useful for a number of reasons. For example, some organizations may want to be able to make claims about the size and growth of their audiences or technologies. Similarly, understanding consumer behavior, such as how consumers interact with a particular web site or group of web sites, may help organizations make decisions that improve their traffic flow or the objective of their web site. In addition, understanding Internet audience visitation and habits may be useful for informing advertising planning, buying, and selling decisions.

In the area of online advertising, an advertiser, such as a company that is selling goods or services or a non-profit entity advancing a particular cause, pays a website owner, known as a “publisher,” to include the advertiser's advertisements into one or more of the publisher's webpages. An advertiser may have its advertisements displayed through multiple publishers or third party advertising networks/brokers, and a publisher may display advertisements from multiple advertisers or third party advertising networks/brokers on any one of its webpages.

FIG. 1 depicts an example of a publisher webpage 120 that includes a plurality of advertisements 131-133. Advertisements 131-133 may comprise image files, Flash™ files, textual elements, or any other kinds of objects or elements that may be used to market products or services. Typically, rather than hosting advertisements 131-133 directly on its server, the publisher will include links or elements (known as “ad-codes”) into the hypertext markup language (HTML) of webpage 120. The ad-codes will instruct users' browsers to retrieve advertisements from ad-servers operated by advertisers or from ad-servers operated by third-party intermediaries, such as advertising networks or brokers. FIG. 1 depicts an exemplary webpage 120 as it might be rendered by a web browser 110 on a client device after having retrieved both the HTML of the webpage from the publisher and advertisements 131-133 from their respective advertisers or third party advertising networks.

In an impression- or view-based advertising compensation model, a publisher may earn a commission from an advertiser each time that a webpage containing an advertisement is viewed by a user. Typically, an advertiser or ad-server will track the number of distinct views or impressions associated with an advertisement by simply counting the total number of instances in which users have downloaded the advertisement (e.g., via hypertext transfer protocol (HTTP) requests) from a server operated by the advertiser or third-party ad network that hosts the advertisement file(s). In some cases, an advertisement's impression count may be limited to the number of unique or distinct users (e.g., as identified by IP addresses, HTTP cookies, or other techniques) that have downloaded the advertisement in connection with a webpage.

However, the traditional reporting approach of equating ad impression counts with download requests has various drawbacks. For example, the total number of download requests for an advertisement may include fraudulent activity (e.g., cookie bombing or cookie stuffing) or may include downloads to users that would not likely be interested in the subject matter of the advertisement or who are not desired by the advertiser. For another example, “views” may be a misnomer because a user may not actually see the advertisement on the visible portion of their computer screen.

Thus, online advertising may be improved by techniques fur verifying or validating ad data and calculating metrics associated with online advertisements that are more relevant to the effectiveness of advertising campaigns.

### SUMMARY

Embodiments are disclosed that provide systems, methods, and non-transitory computer readable media for determining an effectiveness of an online advertisement. In various implementations, the systems, methods and media include components and operations for identifying a set of un-validated impressions, wherein the set of un-validated impressions comprises data indicating a number of times that the online advertisement was downloaded by a client device; determining a set of validated impressions and reporting the set of validated impressions. Components and operations that determine the set of validated impressions may further identify a subset of impressions within the set of un-validated impressions satisfying criteria comprising: fraud criteria; visibility criteria; brand safety criteria; demographic criteria; and geographic criteria.

Additional embodiments are disclosed that provide systems, methods, and non-transitory computer readable media for processing ad impressions associated with an online ad. In various implementations, the systems, methods and media include components and operations for receiving data representing a plurality of ad impressions; determining whether the data representing each ad impression in the plurality of ad impressions meets a plurality of validation requirements; classifying an ad impression as a validated impression on condition that the data representing the ad impression meets the plurality of validation requirements; calculating a count of validated impressions based on the classifying; and providing the count of validated impressions.

Still other embodiments are disclosed that provide systems, methods, and non transitory computer readable media for producing an ad metric associated with an online ad. In various implementations, the systems, methods and media include components and operations for accessing a plurality of validation requirements that represent a target audience for the online ad; totaling the number of different households that are both exposed to interact advertising and that meet the plurality of validation requirements, to produce a validated reach metric; determining the number of validated impressions of the online ad according to the plurality of validation requirements; calculating a validated gross point rating for the online ad using the validated reach metric and the number of validated impressions; and providing access to the validated gross point rating.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a diagram depicting an exemplary publisher webpage that includes third-party advertisements, as rendered by a web browser and displayed on a client device screen;

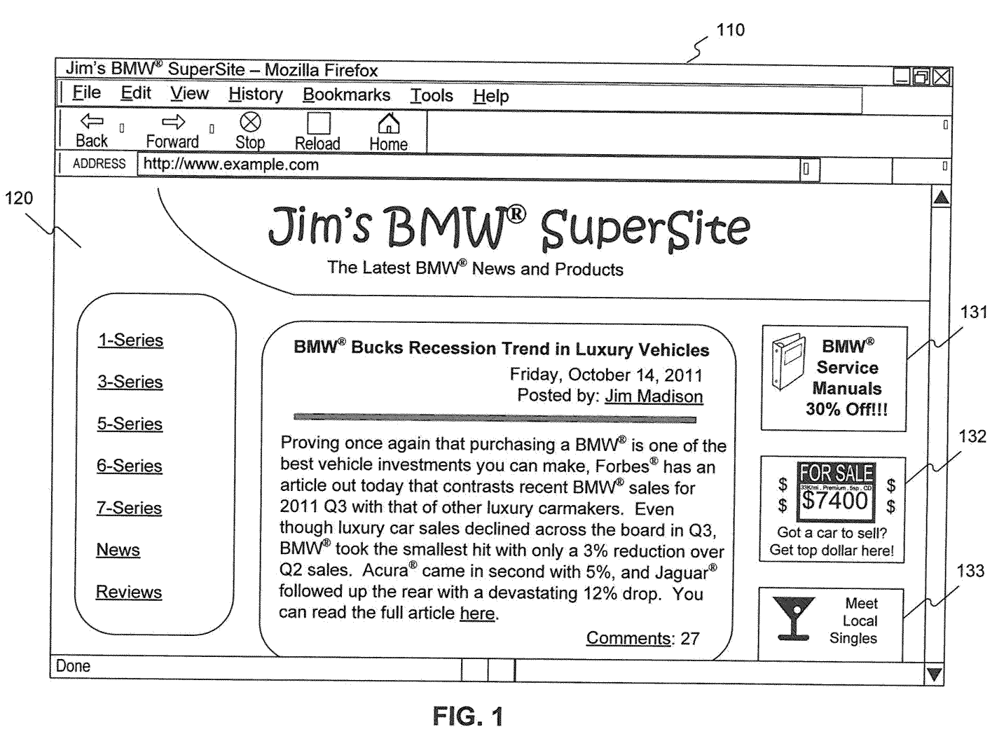

FIG. 2 is a block diagram of an exemplary system for validating ad impressions, consistent with embodiments of the invention;

FIG. 3 is a representation of validation requirements consistent with embodiments of the invention;

FIG. 4 is a flowchart of an exemplary process for verifying online impressions, consistent with embodiments of the invention; and

FIG. 5 is a diagram depicting an exemplary hardware configuration for various devices that may be used to perform one or more operations or processes of the described embodiments, consistent with certain disclosed embodiments of the invention.

### DETAILED DESCRIPTION

The present disclosure addresses improvements to online advertising, including improvements that verify, validate, or otherwise confirm that data describing online ad impressions and/or online ad views and the like meets the needs of advertisers and that the data satisfies criteria defined by or for advertisers (as used herein, the terms “verified” and “validated,” as well as their variants, may be considered synonymous). The present disclosure also describes improvements in measurements and metrics that describe advertising audiences and advertising results based on validated data describing online ad impressions and online ad views.

In some embodiments, an un-validated impression count for an online advertisement may be calculated based on data describing raw, unfiltered download requests associated with an online advertisement or advertisement campaign. In other embodiments, filtering may be done by an ad tag on the client machine, e.g., in real time, such that each impression is reported with a validation assessment (e.g., validated, not validated, 60% validated, etc.) according to the result of the filtering. The un-validated impressions may be filtered by applying validation requirements across a variety of criteria, including one or more of fraud, visibility, brand safety, demographic, and geographic criteria. The validation requirements may be provided and/or applied by a variety of entities, including advertisers, ad servers, or measurement companies. Once the un-validated impressions have been filtered across all of the relevant requirement criteria, the resulting set of validated impressions may be used to calculate improved metrics associated with the online advertisement. For example, in some embodiments, the validated impressions may be used to calculate the verified or validated reach, frequency, gross rating points (GRPs), or sales lift associated with the online advertisement.

By providing improved techniques for verifying or validating impressions and calculating metrics associated with online advertisements, the present disclosure allows for more accurate and/or useful data reporting and understanding of online behavior, and better business decisions in the area of online advertising.

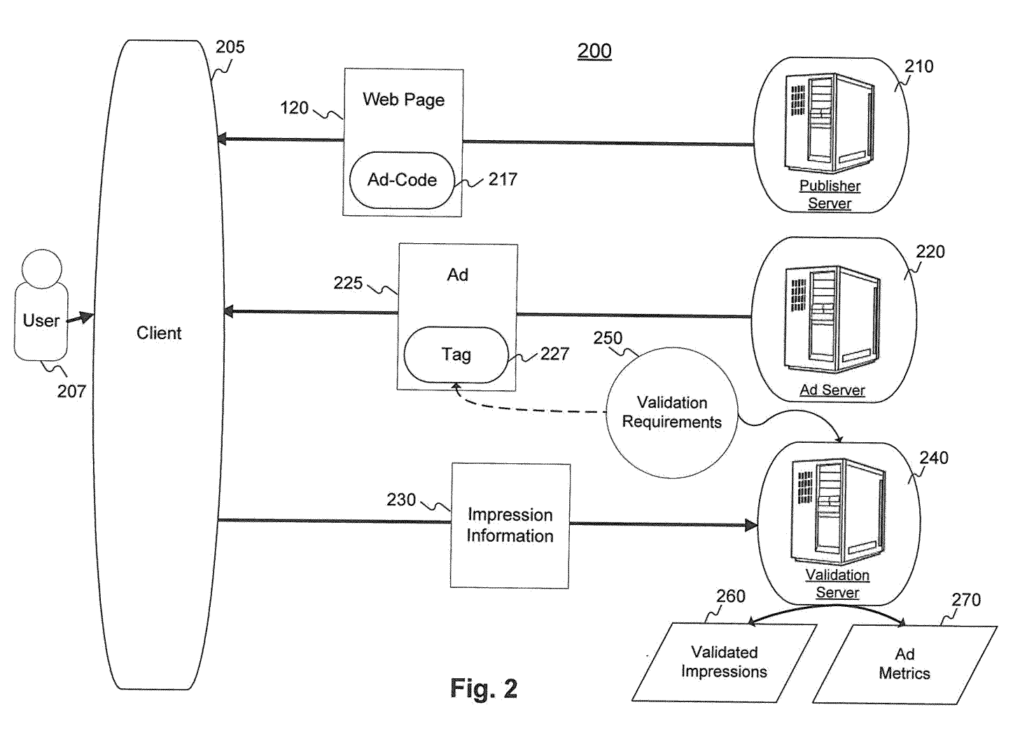

FIG. 2 is a block diagram of an exemplary system 200 for validating ad impressions, consistent with embodiments of the invention. As shown in tads example, system 200 includes a client 205, which receives a web page 120, including an ad code 217, from a publisher server 210. The client 205 may be any computing system used by a user 207, such a personal computer, a laptop computer a tablet computer, a smart phone, or the like. The publisher server 210 may be any computing system that supplies content upon request from a client 205.

In a specific example, the client 205 may execute a browser application (not shown) to send a request (e.g., an HTTP request) to the publisher server 210 for the webpage 120. In response, the publisher server 210 sends a responsive message (e.g., an HTTP response) that includes the webpage 120, for example in the form of an HTML file or document. As shown, the webpage 120 may include the ad code 217 in the form of an object or element that instructs the browser to download an advertisement.

In various embodiments, the ad code 217 may be any kind of element or instruction that is placed within a publisher webpage that instructs a receiving browser to download an advertisement. For example, an ad code 217 could be a simple HTML tag that points to a file on an ad server 220, where the file represents an online advertisement 225.

In the embodiment shown, the ad 225 may include a tag 227. In various embodiments, the tag 227 may be any kind of element, code, or instructions that is placed within the ad 225 and this is executed by the client 205 (e.g., executed by a browser application running on the client 205). In various embodiments, the tag 227 may determine, measure, and/or record a variety of information or metrics related to the ad 225 and the client 205, such as information describing the user 207, the web page 120, the visibility of the ad 225, the geographic location of the client 205, and fraud indicators. In some embodiments, a single tag 227 gathers all the information needed to evaluate the validity of the impression of the ad 225 with respect to the client 205. In other embodiments, more than one tag may be used to gather the information needed to evaluate the validity of an impression. In various embodiments, the tag 227 may transmit or otherwise provide output, such as impression information 230, to another computer.

In some embodiments, the tag 227 may include code, executed by the client 205, that evaluates, at least partially, whether an impression is valid and provide the evaluation results in the impression information 230; while in other embodiments, the tag 227 may only gather information, which is sent to another computer that evaluates the information to determine whether an impression is valid (e.g., impression information 230 supplied to a validation server 240). In some embodiments in which the tag 227 includes code that evaluates or computes whether an impression of the ad 225 is valid, the code may optionally test for one or more validation requirements 250.

In various embodiments, the impression information 230 may be a data packet that includes data fields describing, or that can be used to determine, the demographics of the user 207 (e.g., in terms of demographics such as household income range, previous behaviors, such as buying a specific product or buying from a specific website, etc.), which may be gathered or determined from information stored (e.g., in cookies, etc.) on the client device 205. The impression information 230 may also include data fields describing, or that can be used to determine, the brand safety of the web page 120 that the ad 225 was served with, such as data describing the URI or domain name of the web page 120, data describing content of the web page 120 (e.g., whether it contains certain keywords, whether it contains user generated content, the page's own content categorization indicator, etc.). The impression information 230 may also include data fields describing, or that can be used to determine, the visibility of the ad 225 on the web page 120, such as data describing a percentage of the ad 225 that was displayed on a screen of the client 205, data describing an amount of time that the ad 225 was displayed, data describing how the ad 225 was displayed (e.g., in a certain type of iFrame), and the like. The impression information 230 may also include data fields describing, or that can be used to determine, the geographic location of the client 205 and/or the user 207, such as data describing the IP address of the client 205, data describing a country, state, or postal code associated with the user 207 (e.g., from cookies, etc.), and the like. The impression information 230 may also include data fields describing, or that can be used to determine, the fraud potential of the client 205, such as data describing the IP address of the client 205, data describing a country, state, or postal code associated with the client 205, data describing whether or not the client 205 is associated with a human user 207 (e.g., data indicating an absence of cookies or other stored information associated with humans), and the like. As noted previously, in some embodiments the impression information 230 may include both “raw” data that is later analyzed to determine whether it meets the validation requirements 225, and “results” data which is generated as the result of an analysis performed by the tag code 227 executing on the client device 205.

In various embodiments, an advertiser may provide or specify the validation requirements 250 (e.g., ad campaign requirements) associated with an online advertisement campaign. For example, an advertiser may provide the validation requirements 250 to a third party, which may be any of a variety of entities interested in calculating statistics related to online advertisements associated with the campaign such as, for example, online advertising networks or measurement companies. The validation requirements 250 (e.g., ad campaign requirements) may include specifications or criteria for the target audience for the campaign, such as demographic or geographic requirements (e.g., with respect to client 205 and user 207). The validation requirements 250 may also include brand-safety requirements describing restricted content (e.g., web page 120) that advertisements associated with the campaign should not be associated or displayed with. In various embodiments, the validation requirements 250 may also include anti-fraud requirements (e.g., greater than a threshold (e.g., >50%) probability that an impression is not fraudulent) and visibility requirements 330 (e.g., greater than a threshold (e.g., >60%) probability that an ad was visible on the user's screen). In some embodiments, the validation requirements 250 may be dynamically generated based on historical data associated with past advertisements instead of being explicitly defined by the advertiser. Other techniques for determining the validation requirements 250 may be used.

As mentioned previously, the tag 227 executing on client 205 may transmit or provide the impression information 230 related to display of the ad 225 to another computer, such as the validation server 240. In some embodiments, a browser (not shown) running on the client 205 and running the tag 227 may report the impression information 230 to the validation server 240 via HTTP communication, which may be a standard HTTP request, an asynchronous eXtensible Markup Language (XML) HTTP request, a secure HTTP request, etc. In various embodiments, validation server 240 may be a separate server that is dedicated to collecting and/or analyzing impression information 230 and may be operated by a third party to provide ad validation or verification services (e.g., services that provide validated impressions information 260 and/or ad metrics 270) to publishers, advertisers, third party ad networks, ad-servers, or other entities.

As shown, the validation server 240 may use the validation requirements 250 to analyze or process the impression information 230 and determine whether an impression was valid, e.g., whether an impression met the criteria specified in the validation requirements 250. In various embodiments, the validation server 240 may output validated impressions information 260 describing the results of its analysis. In various embodiments, the validated impressions information 260 may include a count of the number of validated impressions and/or a count of the total number of impressions (e.g., the number of validated impressions plus the number of invalid impressions that did not meet the validation requirements 250). In various embodiments, the validation server 240 may output validated ad metrics 270, which may include ad audience metrics and measurements calculated from the validated impressions information 260, such as a validated gross rating point (GRP), a validated target rating point (TRP), and the like.

In some embodiments, the campaign requirements provided by an advertiser may be combined with other additional requirements in order to generate a set of validation requirements 250. These additional requirements may be provided by a variety of third parties such as, for example, measurement companies. For example, as described above, campaign requirements such as demographic, geographic, and brand-safety criteria may be combined with additional requirements, such as visibility and fraud-detection requirements, in order to generate a set of verification or validation requirements 250 for an online advertisement campaign. Other criteria may additionally or alternatively include criteria such as whether a user 207 that downloads an advertisement 225 has previously consumed content or purchased a product related to the advertisement 225, or whether an advertisement 225 was served to a non-human agent, such as a spider or bot.

In the example shown in FIG. 2, the validation requirements 250 may be applied against unverified impressions for online advertisements associated with the advertising campaign (e.g., as represented in the impression information 230) in order to identify all impressions that meet the validation requirements 250. These validated impressions 260 then represent a subset of all impressions that met the validation requirements 250, which may include ad campaign requirements as well as any additional validation requirements. The validation server 240 may also calculate validated ad metrics 270 using the validated impressions 260. The validated ad metrics 270 may be more accurate and a better representation of the effect of an ad campaign because the validated ad metrics 270 do not consider impressions that did not meet the validation requirements 250 desired by the advertiser (e.g., ads that are not served to the target audience defined by the advertiser in the validation requirements 250).

One of ordinary skill will recognize that the components and implementation details of system 200 are examples presented for conciseness and clarity of explanation. Other components and implementation details may be used. For example, although a single user 207 and client 205 is shown in FIG. 2 for clarity, various embodiments of system 200 will include many thousands of clients and users, and validation server 240 will receive many thousands of packets of impression information 230. Similarly, various embodiments of system 200 will include many publisher servers 210, ad servers 220, and perhaps several validation servers 240. Again similarly, there may be several different ads 225 that are grouped and analyzed together under the same ad campaign.

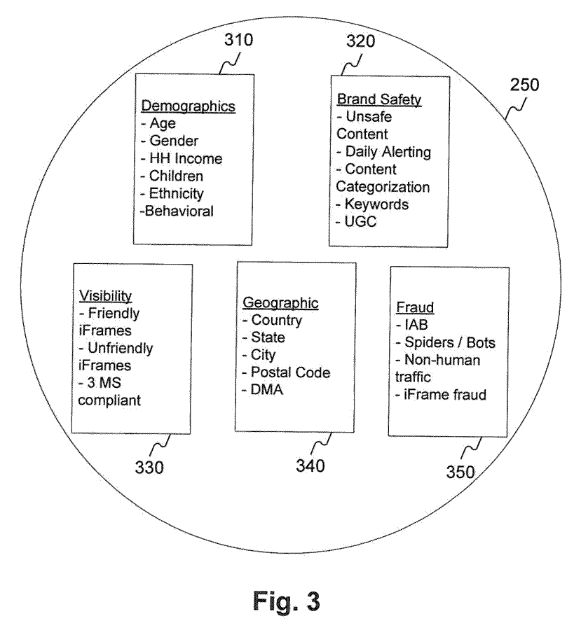

FIG. 3 is a representation of exemplary validation requirements 250 consistent with embodiments of the invention. In the embodiment shown, the validation requirements 250 may include demographic requirements 310 regarding the target demographic or target audience that is to be presented with advertisements 225 associated with an ad campaign. The demographic requirements 310 may include criteria associated with demographics of end-users that view an online ad (e.g., user 207), such as a target age range, target gender, target household income, target number of children, target ethnicity, target past behavior (e.g., buying history), etc. The demographic requirements or criteria may be applied against un-validated impressions (e.g., as represented by impression information 230) in order to filter out any impressions of ad 225 that were served to end-users 207 that did not fall within the target demographic. In one embodiment, each un-validated impression record, (which may, for example, be contained in the impression information 230, or formed by the validation server 240 using the impression information 230) may include identification information associating the impression with a particular client machine 205 or browser that requested the advertisement 225. The identification information may be associated with demographic information regarding the end-user 207 of the client machine 205 or browser.

The demographic information associated with an end-user 207 of a client machine 205 or browser may be determined through a variety of techniques. For example, the client machine 205 may be part of a group of machines whose users have agreed to provide demographic information as part of their participation in a research panel; thus, the identity of the client machine 205 (e.g., its IP address) may be used to look up the stored demographic information describing the user(s) 207, which was provided by the user when they joined the research panel. Alternatively, or in addition, the demographic information associated with an end-user 207 of a client machine 205 or browser may be determined using other techniques, such as through a third-party database or through dynamic analysis of machine traffic. In instances where the un-validated impression is associated with a client machine 205 whose end-user demographic information is known, the demographic requirements can be applied in order to determine if the end-user is within the target demographic. If the end-user is within the target demographic, the un-validated impression can be appropriately designated as being validated against the target demographic, and, e.g., reported in the validated impressions 260 and/or used to calculate validated ad metrics 270.

In the embodiment shown, the validation requirements 250 may include brand-safety requirements 320 regarding the type of content (e.g., web page 120) within which advertisements 225 associated with a relevant campaign can be displayed. The brand-safety requirements 320 may include requirements or criteria defining unsafe or restricted content that the advertiser does not wish to be associated with such as, for example, violent, pornographic, or gambling content. The brand-safety requirements 320 may also include requirements defining whether an advertiser wants its ads 225 to appear on web pages 120 that include User Generated Content (UGC). A webpage 120 that allows users to add comments (e.g., UGC) has little control over whether the page will contain objectionable content in the UGC now, or in the future, UGC comments may be offensive or otherwise undesirable; i.e., not brand safe in the view of advertisers that want to protect the image of their brands.

In one embodiment, each un-validated impression may be analyzed and assigned a flag describing whether the web page 120 that included the advertisement 225 contained any content that did not meet the brand-safety requirements 320 for its advertisement campaign. Other implementations besides flags are possible. The flag may he generated using a variety of techniques. For example, the flag may be generated by content-verification code that is transmitted in the tag 227 with the advertisement 225 and executes on the client device 205 in order to evaluate whether the parent web page 120 contains any content that violates the campaign's brand safety requirements 320, e.g., as specified in the validation requirements 250. Alternatively, the flag may be generated by a device (e.g., the validation server 240) that evaluates publisher webpage URLs associated with advertisement download requests, either before or after serving the advertisements 225, in order to determine whether the publisher webpages 120 contain content that violates the campaign's brand safety requirements 320. If the un-validated impression is flagged as indicating that the advertisement was displayed in a publisher webpage that did not include content violating the campaign's brand-safety requirements 320, then the impression may be designated as being a validated brand-safe impression.

In the embodiment shown, the validation requirements 250 may include visibility requirements 330 that indicate whether a downloaded advertisement 225 was visible, or was likely to have been visible, on a client device 205. The visibility requirements 330 may include criteria (e.g., thresholds) regarding the minimum amount of the advertisement 225 (e.g., 60% of the ad's area) that must be viewable on the client device 205 and the length of time it must be displayed (e.g., 5 seconds) before an impression is considered “visible;” i.e., is considered to have met the visibility requirements 330.

In one embodiment, each un-validated impression may be analyzed and assigned a flag indicating whether the advertisement 225 associated with the impression met the visibility requirements 330 for its advertisement campaign or those imposed by a third party, such as a measurement company. Other implementations besides flags are possible. This flag may be generated using a variety of techniques. For example, the flag may be generated by visibility-verification code in the tag 227 that is transmitted with or in connection with the advertisement 225 and executes on the client device 205 in order to evaluate whether the advertisement 225 was displayed in a manner that met the visibility requirements 330. Examples of this, and other visibility determination techniques, are described in U.S. patent application No. 13/352,134 filed 17 Jan. 2012 and entitled “Unified Content Visibility,” which is hereby incorporated by reference in its entirety. If the un-validated impression is flagged as having met the visibility requirements 330, then the impression may be designated as being a validated visible impression.

In the embodiment shown in FIG. 3, the validation requirements 250 may include geographic requirements 340 regarding the target geographic region in which advertisements 225 associated with a relevant campaign should be, or are desired or targeted to be, presented. The geographic requirements 340 may include criteria describing a relevant geographic region such as, for example, countries, states, cities, postal codes, or designated market areas (DMA). The geographic requirements 340 may be applied against un-validated impressions in order to filter out any impressions that were served to end-users 207 or client machines 205 that were not located within the target geographic region. In one embodiment, each un-validated impression record (e.g., in or from impression information 230) may include information, such as an IP address, that may be used to identify the geographic location of the client device 205 that requested the advertisement 225.

The geographic location of a client machine 205 may be determined through a variety of techniques. For example, the geographic information associated with a client machine 205 (and with a user 207 of that machine) may be determined through a third-party database that links IP addresses to geographic locales. In instances where the un-validated impression is associated with a client machine 205 whose geographic location is capable of determination, the geographic requirements 340 can be applied in order to determine if the machine 205 is within the target geographic area. If the client machine 205 is within the target geographic area, the un-validated impression can be appropriately designated as being validly served within the target geographic area.

In the embodiment shown, the validation requirements 250 may also include fraud requirements 350 that describe when an impression is considered to be associated with fraudulent traffic. The fraud requirements 350 may include criteria for determining if the impression was associated with fraudulent behavior, such as click fraud, “cookie-stuffing” activities, and other forms of display advertisement fraud.

In one embodiment, each un-validated impression may include a flag describing whether the impression is associated with fraudulent traffic or activity. This flag may be generated using a variety of techniques. For example, the flag may be generated by fraud-detection software that reviews internet traffic for patterns associated with click fraud. In addition, or alternatively, the flag may be generated by reviewing the IP address of the requesting entity (e.g., client 205) to determine whether the IP address falls within a black list of IP addresses associated with fraud. In some embodiments, this review may be done by the validation server 240. If the un-validated impression is not flagged as being associated with fraudulent traffic or activity, then the impression may be designated as being a validated non-fraudulent impression.

In various embodiments, the validation requirements 250 may be applied against un-validated impressions in real-time or in batches. In one embodiment, whenever an un-validated impression (e.g., as described in the impression information 230) is logged by a validation server 240, it may be processed against the validation requirements 250 in order to determine whether it is a valid impression. Alternatively, a series of un-validated impression may be stored over a specified period of time, and then the stored un-validated impressions, which may represent a specific ad campaign, may be batch-processed together by a validation server 240 at a later time in order to identify all valid impressions within that time period and/or for that specific ad campaign. Once the validation requirements 250 have been applied against un-validated impressions, the validated impressions may be counted, analyzed, accumulated in a database for further processing, etc.

One of ordinary skill will recognize that the components and implementation details of the validation requirements 250 shown in FIG. 3 are examples presented for conciseness and clarity of explanation. Other components and implementation details may be used. For example, more or fewer requirements 310-350 may be used. For another example, the set of requirements 310-350 may be suggested or provided by a party other than an advertiser, such as, for example, an advertising agency hired by the advertiser.

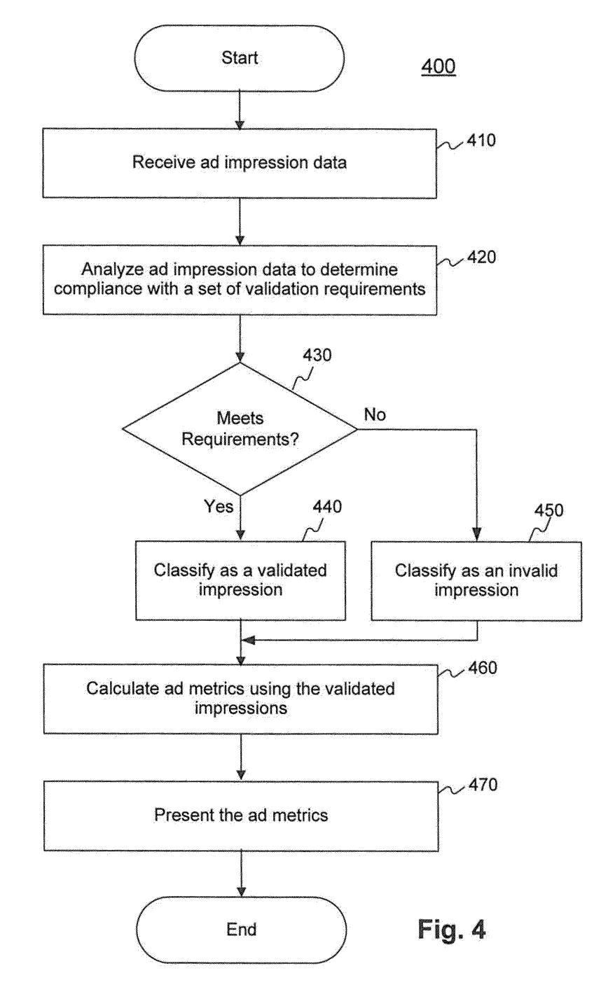

FIG. 4 is a flowchart of an exemplary process 400 for verifying online impressions, consistent with embodiments of the invention. In various embodiments, the process 400 may be implemented in software on a general purpose computing system, in hardware circuitry, in firmware, or in some combination of these. In some embodiments, process 400 may be implemented by a server computer that receives or has access to ad impression data and/or validation requirements, such as the validation server 240 of FIG. 2.

In the embodiment shown, process 400 begins by receiving or otherwise accessing ad impression data (stage 410). In some embodiments, for example as shown in FIG. 2, the ad impression data (e.g., impression information 220) may be received from a client 205 executing an ad tag 227 that transmits the data. In other embodiments, the ad impression data may be received from a storage repository that holds impression data that was previously received from many clients that were served an advertisement, such as ad 225, perhaps for a specified period of time. In some embodiments, the ad impression data may be data describing a group or set of raw (e.g., not yet validated) ad impressions. Other variations are possible.

At stage 420, the process 400 analyzes the ad impression data with respect to a set of validation requirements, and at stage 430, process 400 determines whether the ad impression meets the validation requirements (e.g., is valid or not) and branches accordingly. In some embodiments, for example as described in association with FIG. 2, the validation requirements 250 may be specified or supplied by an advertiser that is advertising using one or more online ads 225. In various embodiments, analyzing the ad impression data in stage 420 may include counting or otherwise determining the number of times that the ad was served to or downloaded by a client device.

In various embodiments, stages 420 and 430 may include determining whether each ad impression meets one or more of demographic criteria/criterions, brand safety criteria/criterions, visibility criteria/criterions, geographic criteria/criterions, and fraud criteria/criterions for the ad, or some subset thereof. For example, in some embodiments, a computing system implementing stages 420 and 430 may compare data fields describing the demographics of a user 207 associated with an ad impression with the standards, rules, tests, or criteria specified for demographics in the validation requirements (e.g., validation requirements 250). For instance, the computing system may compare the household income range associated with the ad impression (e.g., $55,000 per year) to a minimum, maximum, or range of household income specified by the validation requirements (e.g., serve the ad to users with a household income greater than $60,000 per year) and determine whether or not the impression meets the requirements (e.g., not a valid impression because household income is below the $60,000 threshold requirement).

In a similar example, a computing system implementing stages 420 and 430 may compare data fields describing the brand safety of a web page 120 associated with an ad impression with the standards, rules, tests, or criteria specified for brand safety in the validation requirements. For instance, the computing system may compare the URI of the web page (e.g., http://foo.com/adults_only/photos) to a list of unacceptable URIs (e.g., a blacklist) specified by the validation requirements (e.g., do not serve the ad to websites on the blacklist) and determine whether or not the impression meets the requirements (e.g., not a valid impression because the URI http://foo.com/adults_only/photos is associated with a website on the blacklist). For another instance, the computing system may compare web page content analysis results performed by tag 227 (e.g., a search that finds that the web page 120 contains swear words) with swear word criteria specified by the validation requirements (e.g., no swear words) and determine whether or not the impression meets the requirements (e.g., not a valid impression because the web page contains swear words).

In another similar example, a computing system implementing stages 420 and 430 may compare data fields describing the visibility of the ad 225 on the web page 120 associated with an ad impression with the standards, rules, tests, or criteria specified for visibility in the validation requirements. For instance, the computing system may compare a percentage of the area of the ad 225 that was visible on the web page 120 (e.g., 100%) and a length of time that the ad 225 was visible on the web page 120 (e.g., 90 seconds) with a minimum area percentage threshold and display time threshold specified by the validation requirements (e.g., 60% and one second) and determine whether or not the impression meets the requirements (e.g., a valid impression because 100% of area is greater than 60% and 90 seconds is greater than one second).

In yet another similar example, a computing system implementing stages 420 and 430 may compare data fields describing the geographic location of the client device 205 associated with an ad impression with the standards, rules, tests, or criteria specified for geographic location in the validation requirements. For instance, the computing system may use an IP address of the client device 205 to look up the city and state where that IP address is located (e.g., Fairfax, Va.) and then compare that location with a geographic area specified by the validation requirements (e.g., within the Washington, DC metropolitan area) and determine whether or not the impression meets the requirements (e.g., a valid impression because Fairfax Va. is located within the Washington, DC metropolitan area).

In still another similar example, a computing system implementing stages 420 and 430 may compare data fields describing the fraud potential or fraud likelihood of the client device 205 associated with an ad impression with the standards, rules, tests, or criteria specified for fraud in the validation requirements. For instance, the computing system may compare an IP address of the client device 205 (e.g., 123.45.678.9) with a blacklist of known fraudulent IP addresses specified by the validation requirements and determine whether or not the impression meets the requirements (e.g., not a valid impression because the IP address 123.45.678.9 is on the blacklist of known fraudulent IP addresses).

As shown in the example of FIG. 4, if the ad impression data complies with the validation requirements (stage 430, Yes), then processing proceeds to stage 440, where the ad impression is classified as a validated impression. If, on the other hand, the ad impression data does not comply with the validation requirements (stage 430, No), then processing proceeds to stage 450, where the ad impression is classified as an invalid impression. In some embodiments, stage 440 may keep a count of the number of validated impressions and/or stage 450 may keep a count of the number of invalid impressions.

At stage 460, once determined, the set of validated impressions from stage 440 (e.g., validated impressions 260 from FIG. 2) may be used to calculate the ad metrics (e.g., ad metrics 270) associated with an online advertisement (e.g., ad 225) and/or an advertisement campaign. In some embodiments, information regarding the invalid impressions, e.g., the number of invalid impressions (from stage 450) and/or information regarding the number of times that the ad was served to or downloaded by a client device may also be used in the calculation of ad metrics. In various embodiments, ad metrics may include calculated values that reflect or represent the performance or effect of an online ad or set of ads (e.g., an ad campaign) for impressions that reach a target audience member as defined by the validation requirements 250 and may include calculated values that represent the size of the potential audience. Examples of ad metrics include verified or validated reach, validated frequency, validated gross rating point (GRP), validated target rating points (TRP), and validated sales lift. In some embodiments, for example as shown in FIG. 2, these advertising metrics may be calculated by the validation server 240 and output in the validated impression information 260 and/or output separately as validated ad metrics 270. In various embodiments, the validation server 240 may calculate the validated reach, frequency, GRP, TRP, and sales lift metrics using only validated impressions (e.g., from stage 440), which eliminates errors caused by including impressions and/or audience members that did not meet the needs of an advertiser, such as impressions or audience members that did not satisfy the demographic, brand safe, visibility, geographic, and/or fraud criteria specified or desired by the advertiser.

One example of an ad metric that may be calculated by stage 460 is a verified or validated gross rating point (GRP) metric. In conventional techniques, the GRP of an advertisement may be defined as, for a given period of time, a first ratio of the number of people who had the opportunity to see the advertisement in a given population to the total number of people in a given population (e.g., the percentage or ratio of people who were exposed to the medium, such as “interact households;” also known as “reach”) multiplied by a second ratio of the total number of advertisements served in a given population to the number of people who had the opportunity to see an advertisement in a given population (e.g., the ratio at which the ads were served to the population who could have seen them; also known as “frequency”), and further multiplied by 100. In this conventional formulation, for online ads, the total number of online advertisements served corresponds to the raw impression count for a given advertisement or set of advertisements. Thus, given an example with 60 million people in the US who had an opportunity to see an online ad; 300 million total people in the US; and 120 million online ads served (120 million impressions) in the US; the conventional GRP metric yields:

GRP=(60 million/300 million)*(120 million impressions/60 million)*100=40 GRP.

The validated GRP metric removes the inaccuracy and error in the conventional GRP caused by including people who were not validly served with an ad and/or who were not in the target audience, as defined by the validation requirements. Stage 460 may calculate a validated GRP using the validated impressions that were filtering from the raw impression count in stages 420-440. For example, the validated impression count may represent the total number of raw impressions minus the number of invalid impressions, which may include any impressions that did not satisfy specified fraud, visibility, brand safety, demographic, geographic criteria, and/or any subset or combination of such criteria, for example, as identified in stage 450.

More specifically, in various embodiments, stage 460 may calculate a validated GRP as, for a specified time period, a first ratio of the number of people who had the opportunity to see an advertisement in a given population (e.g., interact households), less the number of people who were served an invalid advertisement in a given population (e.g., internet households that are not in the target population), to the total number of people in a given population (this ratio may be termed “validated reach”) multiplied by a second ratio of the total number of advertisements served in a given population, less the number of invalid advertisements served in a given population (e.g., invalid impressions from stage 450), to the number of people who had the opportunity to see a valid advertisement in a given population, less the number of people who were served an invalid advertisement in a given population (this ratio may be termed “validated frequency”), and further multiplied by 100. Thus, given the same example with 60 million people in the US who had an opportunity to see an online ad (e.g., 60 million people with interact access); 300 million total people in the US; 120 million online ads served (120 million impressions) in the US; 60 million online ads invalidly served (60 million invalid impressions); and 20 million people in the US who were invalidly served with the ad (e.g., not in target demographic or geography); the validated GRP metric yields:

Validated GRP=((60 M people with the opportunity to see an ad−20 M people who were invalidly served with the ad)/300 M people in the US)*((120 M impressions in the US−60 M invalid impressions)/(60 M people with the opportunity to see an ad−20 M people who were invalidly served with the ad)*100−20 Validated GRP.

In this equation, total impressions invalid impressions (e.g., 120 M impressions in the US−60 M invalid impressions) is merely a way of expressing the number of validated impressions, and total people with the opportunity to see an ad number of people who were invalidly served with the ad (e.g., 60 M people with the opportunity to see an ad−20 M people who were invalidly served with the ad) is merely a way of expressing the validated reach; i.e., the number of people with the opportunity to validly see the ad or in other words, the number of people in the target population as defined by the validation requirements with the opportunity to see the ad. As this example of validated GRP compared to conventional GRP shows, by considering only validated impressions and the correct target audience (i.e., by removing invalid impressions), the validated GRP calculation removes the error associated with ads that are served to users that are not par of the desired target audience or that otherwise fail to meet the validation requirements.

Another example of an ad metric that may be calculated by stage 460 is a verified or validated target rating point (TRP) metric. In conventional techniques, the TRP of an advertisement may be defined as, for a given time period, a first ratio of the number of people who had the opportunity to see an advertisement in a given population who meet target criteria to the total number of people in a given population who meet the target criteria multiplied by a second ratio of the total number of advertisements served to people who meet the target criteria in a given population to the total number of people who had the opportunity to see an advertisement in a given population who meet the target criteria, and further multiplied by 100. In this conventional formulation, for online ads, the total number of online advertisements served may correspond to the raw impression count for a given advertisement or set of advertisements. Thus, given an example with a target criteria of gender=female; 75 million people in the US who are female and who had an opportunity to see an online ad; 150 million people in the US who are female; and 225 million online ads served to females in the US (225 million impressions) in the US; the conventional TRP metric calculation yields:

TRP=(75 million/150 million)*(225 million impressions/75 million)*1100−150 TRP.

The validated TRP metric removes the inaccuracy and error caused by including target audience people who were not validly served with an ad and/or who were not truly in the target audience, as defined by the validation requirements. Stage 460 may calculate a validated TRP by using the validated impressions filtered from the raw impression count at stages 420-440 using one or more of the above-described validation criteria to derive a total validated impression count at stage 440. For example, the validated impression count may represent the total number of raw impressions minus the number of invalid impressions, which may include any impressions that did not satisfy specified fraud, visibility, brand safety, demographic, geographic criteria, and/or any subset or combination of such criteria, for example, as classified in stage 450.

In various embodiments, stage 460 may calculate a validated TRP as, for a specified time period, a first ratio of people who had the opportunity to see an advertisement in a given population who meet the target criteria (e.g., female internet households), less people who were served an invalid advertisement in a given population who meet the target criteria (e.g., ads that were not visible, ads served from unacceptable, non-brand-safe web pages, etc.), to the total number of people in a given population who meet the target criteria multiplied by a second ratio of the total number of advertisements served in a given population that meet the target criteria, less the number of invalid advertisements served in a given population that meet the target criteria (e.g., invalid impressions from stage 450), to the number of people who had the opportunity to see a valid advertisement in a given population who meet the target criteria, less the number of people who were served an invalid advertisement in a given population who meet the target criteria, and further multiplied by 100. Thus, given the previous example with a target criteria of gender=female; 75 million people in the US who are female and who had an opportunity to see an online ad; 150 million people M the US who are female; 225 million online ads served to females in the US (225 million impressions) in the US; 25 million distinct females were served an invalid online ads; and 100 million invalid ads were served to females in the US; the validate TRP metric calculation yields:

Validated TRP=((75 M−25 M)/150 M)*((225 M impressions−100 M)/75 M 25 M)*100−83.3 Validated TRP.

In various embodiments with respect to validated TRP calculations, different combinations or subsets of validation criteria may be used for determining which impressions were valid vs. the scope of a target population. For example, in some calculations, valid impressions may be defined as the set of impressions that satisfy one or more of fraud, visibility, and brand safety criteria, and the population that meets the target criteria may be defined as the set of persons or client machines that satisfy one or more of demographic or geographic criteria. However, target criteria are not limited to demographic and geographic considerations but may additionally or alternatively include criteria such as whether a person has previously consumed content or purchased a product related to an advertisement, Similarly, other criteria may be used to distinguish valid impressions from invalid impressions, such as whether an advertisement was served to a non-human agent, such as a spider or bot.

In the embodiment shown, by performing the calculations in stage 460 with respect to validated impressions only, the likelihood of error or bias introduced by factors less relevant to the effectiveness of an advertisement campaign may be reduced.

At stage 470, process 400 presents the ad metrics calculated in stage 460. In various embodiments, stage 470 may transmit data, a report, or other information reflecting the ad metrics to another computing system for further processing or to an interested party, such as an advertiser whose products or services are advertised in the ad 225 and/or who shaped the validation requirements 250.

One of ordinary skill will recognize that the components, implementations, and stages of process 400 shown in FIG. 4 are examples presented for conciseness and clarity of explanation. Most details may be changed and stages may be added, deleted, modified, or combined without departing from the principles of this disclosure. For example, stage 460 may be deleted and stage 470 modified to present the validated impressions and/or invalid impressions, which may be further utilized by another machine or process. For another example, process 400 may be executed for one or for many thousands of ad impressions. For instance, stages 420-450 may be repeated to process many thousands of ad impressions that were previously collected over a defined period of time and stored, or which arrive continually in real-time, creating a large set of validated impressions that is processed by step 460.

As another example, stage 460 may calculate other types of validated advertising metrics in addition to those mentioned by removing invalid impressions from consideration. For instance, validated brand lift may be calculated by removing from the “exposed group” persons or users who were not exposed to a validated ad impression. In general, the validated brand lift metric will be higher than the conventionally calculated brand lift metric because exposure is correctly based on validated impressions only.

As yet another example, stage 460 may calculate validated conversion rates and other effectiveness metrics by limiting the “exposed group” to people who were exposed to a validated ad impression. In general the validated conversion rate (or other effectiveness measure) will be higher than the conventionally calculated conversion metric because the exposed group is correctly limited to persons who experienced validated impressions only.

The validated ad metrics calculated by stage 460 (e.g. ad metrics 270), and the validated impressions information 260 may be used for many other purposes in addition to shaping, managing, and judging the effectiveness of online advertising campaigns. For example, the ad metrics and validated impression information may be used to judge the effectiveness of an ad delivery service (e.g., a company that runs ad server 220 and chooses which ad 225 to download on request from client 205) or an ad placement by calculating a validity rate for the delivery service or placement, such as 25% of the ads served or placed by a specified delivery service are valid. In addition, information such as the validity rate may be used to adjust bidding for ad placement. For instance, bidding $1.00 for serving an ad with a service or placement that has a 50% validity rate may be as cost effective, or have the same ROI, as bidding $0.50 for serving an ad with a service or placement that has a 25% validity rate, as the cost per validated impression is the same.

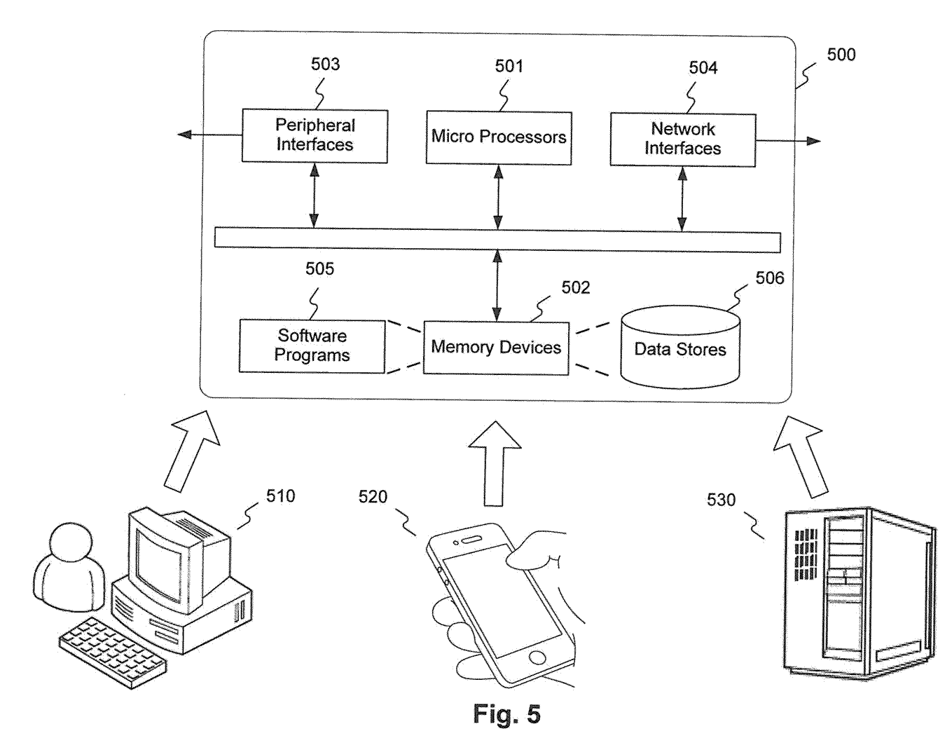

FIG. 5 is a diagram depicting an exemplary hardware configuration for various devices that may be used to perform one or more operations of the described embodiments. In various embodiments, operations for determining the validity of an impression of an advertisement 225 served to a client device 205, and associated metrics, may be performed by the client device 205 itself, which may be, for example, a traditional personal computing device 510, such as a desktop or laptop computer, a mobile device 520, such as a smartphone or tablet, a kiosk terminal, a global position system (GPS) device, etc. The client device may receive client-side code for performing ad-impression-validity determinations (e.g., in a tag 227) from one or more external devices 530, such as a web server involved in serving webpages, advertisements, tags, or ad-codes (e.g., publisher server 210 and ad server 220) to the client device 205. In various embodiments, operations for determining the validity of an impression of an advertisement 225 served to a client device 205, and associated metrics, may alternatively or additionally be performed by a server 530 that processes ad impression data 230 from the client device 205, such as the validation server 240 or the like.

As represented in FIG. 5, any of devices 510-530 may comprise one or more microprocessors 501 of varying core configurations and clock frequencies; one or more memory devices or computer-readable media 502 of varying physical dimensions and storage capacities, such as flash drives, hard drives, random access memory, etc., for storing data, such as images, files, and program instructions for execution by one or more microprocessors 501; one or more network interfaces 504, such as Ethernet adapters, wireless transceivers, or serial network components, for communicating over wired or wireless media using protocols, such as Ethernet, wireless Ethernet, code divisional multiple access (CDMA), time division multiple access (TDMA), etc.; and one or more peripheral interfaces 503, such as keyboards, mice, touchpads, computer screens, touchscreens, etc., for enabling human interaction with and manipulation of devices 510, 520, or 530. In some embodiments, the components of devices 510, 520, or 530 need not be enclosed within a single enclosure or even located in close proximity to one another.

Memory devices 502 may further be physically or logically arranged or configured to provide for or store one or more data stores 506, such as one or more file systems or databases, e.g., to store validation requirements 250 and impression information 230, and one or more software programs 505, which may contain interpretable or executable instructions for performing one or more of the disclosed embodiments, such as process 400 of FIG. 4. Those skilled in the art will appreciate that the above-described componentry is exemplary only, as devisees 510, 520, and 530 may comprise any type of hardware componentry, including any necessary accompanying firmware or software, for performing the disclosed embodiments. Devices 510, 520, or 530 may also be implemented in part or in whole by electronic circuit components or processors, such as application-specific integrated circuits (ASICs) or field-programmable gate arrays (FPGAs).

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention.

Likewise, the stages and components described need not be performed or connected in the same sequence or manner discussed or with the same degree of separation. Various stages and components may be omitted, repeated, combined, or divided, as necessary to achieve the same or similar objectives or enhancements. Accordingly, the invention is not limited to the above-described embodiments, but instead is defined by the appended claims in light of their full scope of equivalents.

What is claimed is:

1. A processor-implemented method of determining an effectiveness of an online advertisement, the method comprising:
identifying, using a processor, a set of un-validated impressions, wherein the set of un-validated impressions comprises data indicating a number of times that the online advertisement was downloaded by a client device;
determining, using the processor, a set of validated impressions, wherein the determining the set of validated impressions comprises identifying a subset of impressions within the set of un-validated impressions satisfying criteria comprising:
fraud criteria;
visibility criteria;
brand safety criteria;
demographic criteria; and
geographic criteria; and
reporting the set of validated impressions.

2. The method of claim 1, further comprising:
calculating a performance metric of the online campaign based on the set of validated impressions.

3. The method of claim 2, wherein the performance metric is a validated reach that is calculated using the validation requirements to determine the number of people with an opportunity to see the online advertisement.

4. The method of claim 3, wherein the performance metric is a validated gross rating point that is calculated using the set of validated impressions and the validated reach and without using invalid impressions.

5. The method of claim 2, wherein the performance metric is a validated gross rating point that is calculated using the set of validated impressions and without using invalid impressions.

6. The method of claim 2, wherein the performance metric is a validated target rating point that is calculated using the set of validated impressions and without using invalid impressions.

7. A method, implemented using a processor, for processing ad impressions associated with an online ad, the method comprising:
receiving data representing a plurality of ad impressions;
determining, using the processor, whether the data representing each ad impression in the plurality of ad impressions meets a plurality of validation requirements;
classifying, using the processor, an ad impression as a validated impression on condition that the data representing the ad impression meets the plurality of validation requirements;
calculating a count of validated impressions based on the classifying; and
providing the count of validated impressions.

8. The method of claim 7, wherein determining whether the data representing each ad impression in the plurality of ad impressions meets the plurality of validation requirements comprises:
determining whether each ad impression in the plurality of ad impressions meets a visibility requirement.

9. The method of claim 8, wherein determining whether the data representing each ad impression in the plurality of ad impressions meets a plurality of validation requirements further comprises:
determining whether each ad impression in the plurality of ad impressions meets a demographic requirement.

10. The method of claim 8, wherein determining whether the data representing each ad impression in the plurality of ad impressions meets a plurality of validation requirements further comprises:
determining whether each ad impression in the plurality of ad impressions meets a brand safety requirement.

11. The method of claim 8, wherein determining whether the data representing each ad impression in the plurality of ad impressions meets a plurality of validation requirements further comprises:
determining whether each ad impression in the plurality of ad impressions meets a geographic requirement.

12. The method of claim 8, wherein determining whether the data representing each ad impression in the plurality of ad impressions meets a plurality of validation requirements further comprises:
determining whether each ad impression in the plurality of ad impressions meets a fraud requirement.

13. The method of claim 7, wherein providing the count of validated impressions comprises:
calculating a metric representing performance of the online ad using the count of validated impressions and without using ad impressions that are not classified as validated impressions.

14. The method of claim 7, Farther comprising:
calculating a validated reach that is equal to the number of people that both have an opportunity to see the online ad and that meet the plurality of validation requirements.

15. The method of claim 14, further comprising:
calculating a validated gross rating point for the online ad using the validated reach and the count of validated impressions.

16. The method of claim 7, further comprising:
calculating a validated target rating point for the online ad using the count of validated impressions.

17. The method of claim 7, wherein the data representing each ad impression in the plurality of ad impressions is generated by a single tag executed by a client device.

18. The method of claim 17, wherein the single tag generates data sufficient to determine whether the ad impression meets the plurality of validation requirements.

19. A method, implemented using a processor, for producing an ad metric associated with an online ad, the method comprising:
accessing, using the processor, a plurality of validation requirements that represent a target audience for the online ad;
totaling, using the processor, the number of different households that are both exposed to interact advertising and that meet the plurality of validation requirements, to produce a validated reach metric;
determining, using the processor, the number of validated impressions of the online ad according to the plurality of validation requirements;
calculating, using the processor, a validated gross point rating for the online ad using the validated reach metric and the number of validated impressions; and
providing access to the validated gross point rating.

20. The method of claim 19, wherein calculating a validated gross point rating comprises:
dividing the validated reach metric by the number of different households that are exposed to internet advertising to produce a first dividend;
dividing the number of validated impressions by the validated reach metric to produce a second dividend;
multiplying the first dividend by the second dividend to produce a product; and
multiplying the product by 100 to produce the validated gross point rating.

21. The method of claim 19, wherein determining the number of validated impressions of the online ad according to the plurality of validation requirements comprises:
determining whether data representing each ad impression in a plurality of ad impressions meets the plurality of validation requirements; and
counting each ad impression that meets the plurality of validation requirements in the number of validated impressions.

22. The method of claim 21, wherein determining whether the data representing each ad impression in the plurality of ad impressions meets the plurality of validation requirements comprises:
determining whether each ad impression in the plurality of ad impressions meets a visibility requirement.

23. The method of claim 19, wherein totaling the number of different households that are both exposed to internet advertising and that meet the plurality of validation requirements comprises:
determining whether a household meets a demographic requirement; and
counting each household that meets the demographic requirement in the validated reach metric.

24. The method of claim 19, wherein totaling the number of different households that are both exposed to internet advertising and that meet the plurality of validation requirements comprises:
determining whether a household meets a geographic requirement; and
counting each household that meets the geographic requirement in the validated reach metric.
